(19) United States
(12) Patent Application Publication
(10) Pub. No.: US 2026/0159059 A1
(43) Pub. Date: Jun. 11, 2026

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Choong Sik SHIN, Yongin-si (KR)

(73) Assignee: HYUNDAI MOBIS CO., LTD., Seoul (KR)

(21) Appl. No.: 19/289,527

(22) Filed: Aug. 4, 2025

(30) Foreign Application Priority Data
Dec. 5, 2024 (KR) 10-2024-0179715
Dec. 5, 2024 (KR) 10-2024-0179716

(51) Int. Cl. B60T 13/74; F16D 65/18; F16D 125/40

(52) U.S. Cl. CPC B60T 13/746; F16D 65/18; F16D 2125/40

(57) ABSTRACT

Provided is a brake apparatus for a vehicle, including a caliper body configured to have a cylinder, a piston portion movably arranged in the cylinder and arranged to face a brake pad, a nut screw portion arranged in the piston portion and configured to receive rotational force from an actuator portion and rotate accordingly, and a bolt screw portion configured to include a bolt body coupled to the nut screw portion and receiving rotational force from the nut screw portion, and a bolt head separately formed from the bolt body, coupled to the bolt body, and arranged to face the piston portion, wherein the bolt head presses the piston portion as the bolt body moves inside the cylinder in response to rotation of the nut screw portion.

### CROSS-REFERENCE TO RELATED APPLICATION

The present application claims priority and the benefit of Korean Patent Application Nos. 10-2024-0179715 and 10-2024-0179716, filed on Dec. 5, 2024 and Dec. 5, 2024, respectively, in the Korean Intellectual Property Office, the entire disclosure of which is incorporated herein by reference.

### BACKGROUND

### Field

Exemplary embodiments of the present disclosure relate to a brake apparatus for a vehicle and, more particularly, to a brake apparatus for a vehicle capable of ensuring stable braking performance.

### Discussion of the Background

In general, a brake apparatus for a vehicle presses a piston using driving force to bring a pad and a disc into close contact, and brakes the vehicle using frictional force between the pad and the disc.

Among brake apparatuses for a vehicle, an electro mechanical brake (EMB) generates braking force by pressing the piston through a mechanism that does not use hydraulic pressure, but instead mounts a motor-driven actuator on a caliper and converts the rotational motion of a screw into the linear motion of a nut, or the rotational motion of a nut into the linear motion of a screw.

The EMB enables active braking and independent braking for each wheel, allowing not only general main braking but also additional functions such as an anti-lock brake system (ABS), electronic stability control (ESC), traction control system (TCS), and automatic emergency braking (AEB), and enhanced performance may be achieved because there is no hydraulic transmission delay.

Conventionally, bolt screw-driven type brake apparatuses have been mainly used, resulting in difficulty reducing the axial length (overall length) of the EMB caliper. In addition, conventionally, when the piston is tilted relative to the central axis, braking load is not stably generated, and durability is compromised.

When using a thrust bearing in the bolt screw-driven type brake apparatus, issues arise such as an increase in the axial length (overall length) of the EMB caliper, inability to sufficiently ensure the efficiency of the thrust bearing, and compromised durability.

The related art of the present disclosure is disclosed in Korean Patent Application Publication No. 10-2024-0054695 (published on Apr. 26, 2024 and entitled “BRAKE APPARATUS FOR VEHICLE”).

### SUMMARY

Various aspects of the present disclosure is directed to providing a nut screw-driven type brake apparatus for a vehicle capable of reducing an axial length of an EMB caliper.

An aspect of the present disclosure is directed to providing a brake apparatus for a vehicle in which a bolt body and a bolt head of a bolt screw portion are manufactured as separate components.

An aspect of the present disclosure is directed to providing a brake apparatus for a vehicle capable of increasing the contact diameter of the bolt head that is in contact with a piston portion.

An aspect of the present disclosure is directed to providing a brake apparatus for a vehicle that allows rolling motion between the bolt screw portion and a nut screw portion.

An aspect of the present disclosure is directed to providing a brake apparatus for a vehicle capable of securely fixing a bearing portion in position on a nut screw portion.

A brake apparatus for a vehicle according to an aspect of the present disclosure includes a caliper body configured to have a cylinder, a piston portion movably arranged in the cylinder and arranged to face a brake pad, a nut screw portion arranged in the piston portion and configured to receive rotational force from an actuator portion and rotate accordingly, and a bolt screw portion configured to include a bolt body coupled to the nut screw portion and receiving rotational force from the nut screw portion, and a bolt head separately formed from the bolt body, coupled to the bolt body, and arranged to face the piston portion, wherein the bolt head presses the piston portion as the bolt body moves inside the cylinder in response to rotation of the nut screw portion.

The bolt head may have a larger outer diameter than the bolt body.

The bolt head may include a head connection portion coupled to the bolt body and a head expansion portion configured to extend from the head connection portion toward the piston portion and have a larger outer diameter than the head connection portion.

The head expansion portion may include a curved surface portion on an outer periphery facing the piston portion, and the head expansion portion may be in contact with the piston portion on the curved surface portion.

In response to tilting of the piston portion relative to a central axis, the head expansion portion may perform rolling motion relative to the piston portion on the curved surface portion.

The piston portion may have a planar portion at an area in contact with the curved surface portion.

The bolt body may be coupled to the nut screw portion via a ball member on an inner surface of the nut screw portion.

The brake apparatus for a vehicle may further include a bearing portion arranged between the cylinder and the nut screw portion, and configured to support the nut screw portion to allow the nut screw portion to rotate in the cylinder.

In response to tilting of the piston portion relative to a central axis, the nut screw portion may perform rolling motion relative to the bearing portion.

The bearing portion may include an outer ring portion in contact with an inner surface of the cylinder and a bearing ball arranged between the outer ring portion and the nut screw portion, wherein the nut screw portion has a rolling contact portion at an area facing the bearing ball.

A brake apparatus for a vehicle according to another aspect of the present disclosure includes a caliper body configured to have a cylinder, a piston portion movably arranged in the cylinder and arranged to face a brake pad, a nut screw portion arranged in the piston portion and configured to receive rotational force from an actuator portion and rotate accordingly, a bolt screw portion configured to move inside the cylinder in response to rotation of the nut screw portion and press the piston portion, a bearing portion arranged between the cylinder and the nut screw portion, and configured to support the nut screw portion to allow the nut screw portion to rotate in the cylinder, and a position fixing ring portion configured to contact and support the bearing portion to fix the bearing portion in position on the nut screw portion.

The bearing portion may include an outer ring portion in contact with an inner surface of the cylinder, an inner ring portion rotatably arranged inside the outer ring portion and configured to be in contact with the nut screw portion, and a bearing ball arranged between the outer ring portion and the inner ring portion.

The position fixing ring portion may include a contact plate portion that is in contact with at least part of the outer ring portion.

An insertion groove portion into which the position fixing ring portion is inserted may be provided on an outer surface of the nut screw portion.

The position fixing ring portion may have a V-shaped cross section, and an edge portion of the position fixing ring portion may be inserted into the insertion groove portion.

The position fixing ring portion may include an elastically deformable material.

The inner ring portion may have a rolling contact portion at an area facing the bearing ball.

The inner ring portion may include a lower bottom portion connected to one side of the rolling contact portion and an upper step portion connected to an opposite side of the rolling contact portion and configured to protrude outward compared to the lower bottom portion.

The rolling contact portion may be formed as a concave curved surface facing inward and formed along the whole outer periphery of the inner ring portion.

In the brake apparatus for a vehicle, the bolt head is manufactured separately from the bolt body, which allows for improved shape flexibility of the bolt head.

In the brake apparatus for a vehicle, as the contact diameter of the bolt head that is in contact with the piston portion is increased, the load may be stably transmitted to the piston portion.

In the brake apparatus for a vehicle, since rolling motion may be performed at a front portion of the bolt screw portion and an outer portion of the nut screw portion, load concentration on the ball member may be prevented, thereby improving durability of the apparatus as well as ensuring robustness against tilting of the piston portion.

In the brake apparatus for a vehicle, the bearing portion may be securely fixed in position on the nut screw portion.

In the brake apparatus for a vehicle, since the nut screw portion is press-fitted into the bearing portion and the position fixing ring portion contacts and supports the nut screw portion, durability of the apparatus may be improved.

In the brake apparatus for a vehicle, since rolling motion may be performed at the front portion of the bolt screw portion and the outer portion of the nut screw portion, load concentration on the ball member may be prevented, thereby improving durability of the apparatus as well as ensuring robustness against tilting of the piston portion.

### BRIEF DESCRIPTION OF THE DRAWINGS

FIG. 1 is a perspective view showing a brake apparatus for a vehicle according to an embodiment of the present disclosure.

FIG. 2 is a cross-sectional view schematically showing a brake apparatus for a vehicle according to the embodiment of the present disclosure.

FIG. 3 is a partially enlarged view of FIG. 2.

FIG. 4 is a partially enlarged view of FIG. 3.

FIG. 5 is a perspective view showing an actuator portion of a brake apparatus for a vehicle according to the embodiment of the present disclosure.

FIG. 6 is a perspective view showing a brake apparatus for a vehicle according to another embodiment of the present disclosure.

FIG. 7 is a cross-sectional view schematically showing a brake apparatus for a vehicle according to the embodiment of the present disclosure.

FIG. 8 is a partially enlarged view of FIG. 7.

FIG. 9 is a partially enlarged view of FIG. 8.

FIG. 10 is a view showing a state in which a position fixing portion is mounted to a nut screw portion in a brake apparatus for a vehicle according to the embodiment of the present disclosure.

FIG. 11 is a perspective view of a position fixing portion according to the embodiment of the present disclosure.

FIG. 12 is a perspective view showing an actuator portion of a brake apparatus for a vehicle according to the embodiment of the present disclosure.

### DETAILED DESCRIPTION

Hereinafter, embodiments of a brake apparatus for a vehicle according to the present disclosure will be described in detail with reference to the accompanying drawings. In this process, the thickness of lines and the size of elements illustrated in the drawing may be exaggerated for clarity and convenience of description. In addition, the terms used below are defined in consideration of the functions thereof in the present disclosure and may vary depending on the intention of a user or an operator or common practice. Therefore, these terms should be contextually defined in light of the present specification.

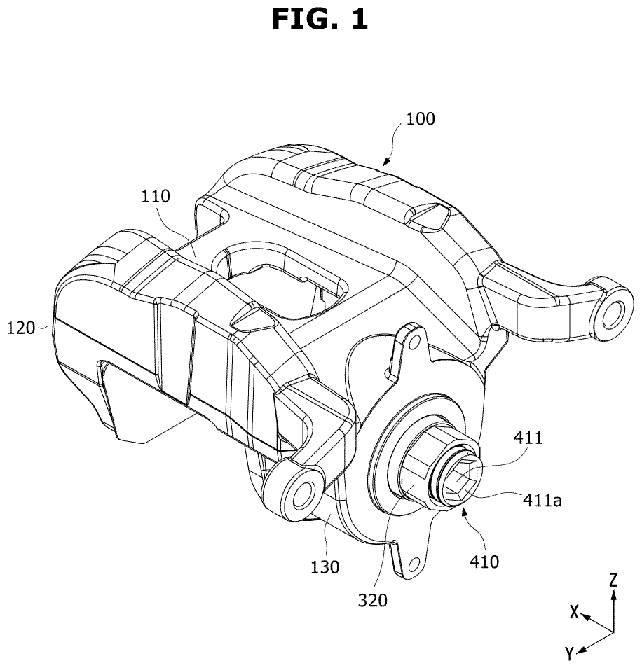

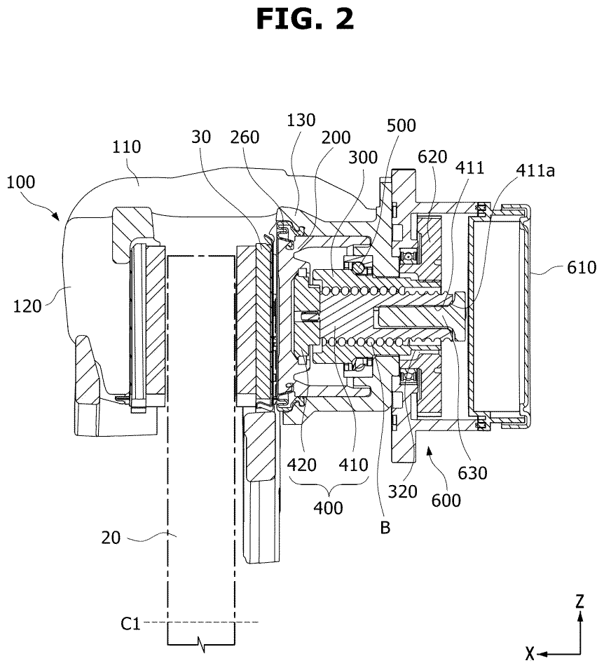

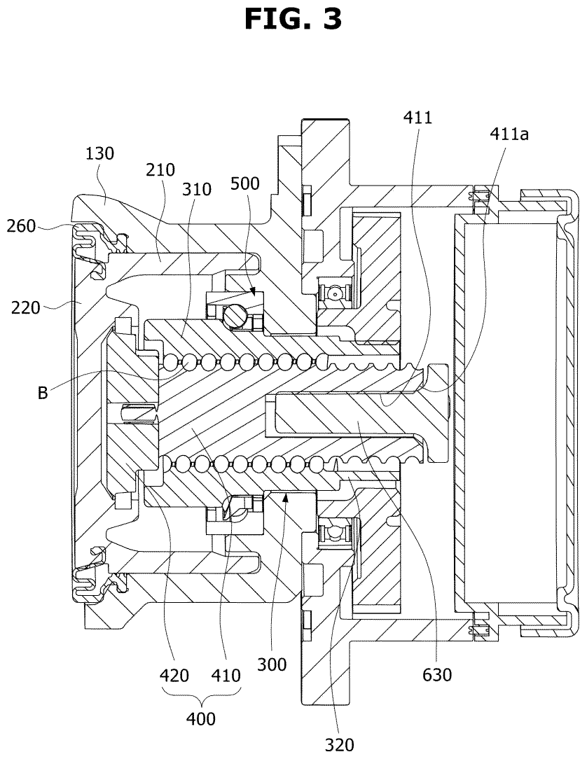

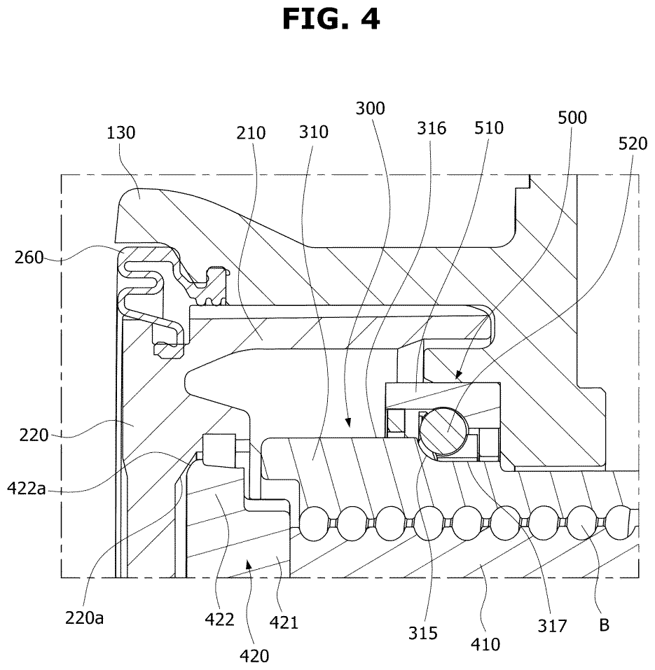

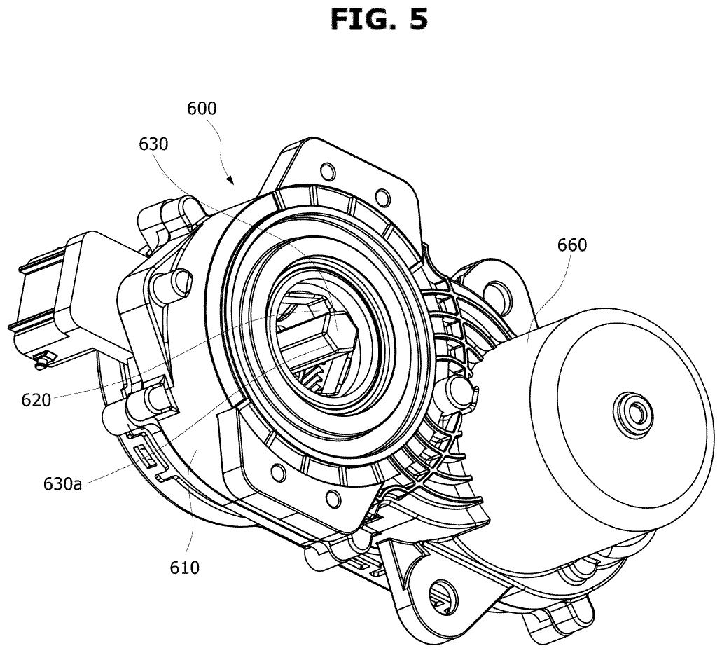

FIG. 1 is a perspective view showing a brake apparatus for a vehicle according to an embodiment of the present disclosure. FIG. 2 is a cross-sectional view schematically showing a brake apparatus for a vehicle according to the embodiment of the present disclosure. FIG. 3 is a partially enlarged view of FIG. 2. FIG. 4 is a partially enlarged view of FIG. 3. FIG. 5 is a perspective view showing an actuator portion of a brake apparatus for a vehicle according to the embodiment of the present disclosure.

Referring to FIGS. 1 to 5, a brake apparatus for a vehicle according to an embodiment of the present disclosure may include a caliper body 100, a piston portion 200, a nut screw portion 300, and a bolt screw portion 400.

The caliper body 100 may form the outer shape of the brake apparatus for a vehicle and surround or support the piston portion 200, the nut screw portion 300, and the bolt screw portion 400.

The caliper body 100 may include a bridge 110, a finger 120, and a cylinder 130.

The bridge 110 may form the outer appearance of a central portion of the caliper body 100 and support the finger 120 and the cylinder 130. The bridge 110 may be connected to a carrier (not shown), which is fixed to a knuckle (not shown) or the like via a guide rod (not shown).

The lower surface of the bridge 110 may be arranged to face a circumferential surface of a brake disc 20 with a predetermined distance therebetween. Both sides of the bridge 110 may extend in a first direction (+X direction in FIG. 2) and in a second direction opposite to the first direction (−X direction in FIG. 2), relative to the brake disc 20.

A pair of brake pads 30 may be arranged below the bridge 110. The pair of brake pads 30 may be arranged to face each other with the brake disc 20 interposed therebetween.

One surface of the brake pad 30 facing the brake disc 20 may have a friction pad attached, which includes a material with a high coefficient of friction such as rubber.

The finger 120 may extend downward from one side of the bridge 110. The finger 120 may be arranged to face one of the pair of brake pads 30.

The cylinder 130 may extend downward from the opposite side of the bridge 110. The cylinder 130 may have a hollow columnar shape. One side of the cylinder 130 (left side in FIG. 2) may be arranged to face the other of the pair of brake pads 30.

One side of the cylinder 130 may be open, and the open side of the cylinder 130 may be spaced a predetermined distance apart from the brake pad 30 that is spaced in the second direction from the brake disc 20.

The central axis of the cylinder 130 may be arranged parallel to a central axis C1 of the brake disc 20. The central axis of the cylinder 130 may be spaced apart from the central axis C1 of the brake disc 20 along a third direction (+Z direction in FIG. 2).

The third direction may be perpendicular to the first and second directions and may be exemplified as the direction from the central axis C1 of the brake disc 20 toward the central axis of the cylinder 130.

When the lower surface of the bridge 110 is arranged parallel to the ground, the third direction may be the direction perpendicular to the ground, that is, the upward direction along the Z-axis direction based on FIG. 2.

The piston portion 200 may be movably arranged in the first direction (+X direction in FIG. 2) or the second direction (−X direction in FIG. 2) within the cylinder 130. The piston portion 200 may be arranged inside the cylinder 130.

The piston portion 200 may have a hollow columnar shape. The side of the piston portion 200 facing the brake pad 30 may be closed. The piston portion 200 may be arranged along the longitudinal direction of the cylinder 130.

The outer surface of the piston portion 200 may be slidably supported by the inner surface of the cylinder 130. Alternatively, the outer surface of the piston portion 200 may be spaced a predetermined distance apart from the inner surface of the cylinder 130.

The piston portion 200 may protrude outward from the cylinder 130 by moving in the first direction and press the brake pad 30, arranged to face the cylinder 130, toward the brake disc 20. This allows the brake apparatus for a vehicle to generate braking force.

In response to movement of the piston portion 200 in the second direction, the piston portion 200 may be separated from the brake pad 30. Accordingly, the pressing force applied by the piston portion 200 to the brake pad 30 is released, and the braking force of the brake apparatus for a vehicle disappears.

The piston portion 200 may include a piston body 210 and a piston head 220.

The piston body 210 may have a hollow columnar shape, and the piston head 220 may be connected to the piston body 210 to close one side of the piston body 210 (left side in FIG. 3). The piston head 220 is arranged on the side that faces the brake pad 30 between the two open sides of the piston body 210, and closes the open area of the piston body 210.

A bolt screw portion 400 may be arranged inside the piston portion 200. A bolt body 410 and a bolt head 420 of the bolt screw portion 400 are surrounded by the piston body 210. The bolt head 420 may be arranged to be inserted into the piston head 220.

A piston boot 260 may be installed inside the cylinder 130 to prevent the entry of external foreign substances and to seal the interior of the cylinder 130. The piston boot 260 may be installed between the cylinder 130 and the piston portion 200. The piston boot 260 may be coupled to the piston body 210 or the piston head 220 and press-fitted inside the cylinder 130.

The piston boot 260 may be formed to surround the piston portion 200. The piston boot 260 may include an elastically deformable material. For example, the piston boot 260 may be made of a rubber material. The piston boot 260 may be formed to have a corrugated shape.

The nut screw portion 300 may be rotatably arranged in the cylinder 130 and coupled to the bolt screw portion 400. A bearing portion 500 that rotatably supports the nut screw portion 300 may be installed inside the cylinder 130. The bearing portion 500 may be a ball bearing arranged between the cylinder 130 and the nut screw portion 300.

The nut screw portion 300 may have a hollow columnar shape with both end portions open. The nut screw portion 300 may be arranged inside the cylinder 130, and the central axis thereof may be aligned coaxially with the central axis of the cylinder.

One side of the nut screw portion 300 (left side in FIG. 2) may be arranged to face the inner surface of the piston portion 200 (right side in FIG. 2) with a predetermined distance therebetween. The other side of the nut screw portion 300 (right side in FIG. 2) may pass through the cylinder 130 and protrude outward from the cylinder 130.

The inner surface of the nut screw portion 300 may be arranged to face the outer surface of the bolt screw portion 400. The inner peripheral surface of the nut screw portion 300 may be formed with a ball rail on which one side circumference of a spherical ball member B is seated. This ball rail may extend helically along the longitudinal direction of the nut screw portion 300 to provide a circulation path for the ball member B.

The nut screw portion 300 may receive rotational force generated from the actuator portion 600 through a power transmission portion during operation of the actuator portion 600, and may rotate clockwise or counterclockwise about the central axis.

The nut screw portion 300 may include a nut screw body 310 and a nut screw tail 320.

Most of the nut screw body 310 may be arranged inside the cylinder 130, and the nut screw tail 320 may be entirely or mostly exposed outside the cylinder 130. The nut screw body 310 may be surrounded by the piston body 210.

The nut screw tail 320 may have a non-circular columnar shape. Non-circular refers to a shape that is not perfectly circular and includes shapes such as oval, polygonal, and others. In the present embodiment, the nut screw tail 320 has a polygonal columnar shape, specifically a substantially hexagonal columnar shape.

The bolt screw portion 400 may move in the first direction and the second direction inside the cylinder 130 in response to rotation of the nut screw portion 300. The bolt screw portion 400 may be arranged inside the nut screw portion 300. The bolt screw portion 400 may be arranged to pass through both end portions of the nut screw portion 300.

The bolt screw portion 400 may move in the first direction, which is a direction toward the brake pad 30, so that the piston portion 200 presses the brake pad 30. In addition, the bolt screw portion 400 may move in the second direction, opposite to the first direction, to release pressure on the piston portion 200.

The bolt screw portion 400 may include a bolt body 410 and a bolt head 420.

The bolt body 410 may be coupled to the nut screw portion 300 and receive rotational force from the nut screw portion 300. The bolt head 420 may be provided separately from the bolt body 410. The bolt body 410 may be press-fitted and integrated with the bolt head 420. For example, the bolt body 410 may be press-fitted with serration to the bolt head 420.

Since the bolt head 420 is manufactured separately from the bolt body 410, the shape flexibility of the bolt head 420 may be improved. In particular, depending on the specifications of the brake apparatus for a vehicle, the shape of the bolt head 420 may be modified. By forming the bolt head 420 separately from the bolt body 410 that is relatively easy to standardize, customization is facilitated and design freedom increases. According to the present embodiment, based on changes in the size of the piston portion 200, the contact diameter of the bolt head 420 may be easily changed accordingly.

When the bolt body 410 moves translationally in the first direction inside the cylinder 130 in response to the rotation of the nut screw portion 300, the bolt head 420 arranged in front of the bolt body 410 (left side in FIG. 2) presses the piston portion 200.

The bolt body 410 may have a columnar shape with an approximately circular cross-section. The bolt body 410 may be arranged inside the cylinder 130, and the central axis thereof may be aligned coaxially with the central axis of the cylinder 130. The bolt body 410 may be coupled to the nut screw portion 300 via the ball member B.

The outer circumferential surface of the bolt body 410 may be formed with a ball rail (not shown) on which the ball member B is seated. The ball rail may extend helically along the longitudinal direction (left-right direction in FIG. 2) of the bolt body 410 to provide a circulation path for the ball member B. Accordingly, in response to rotation of the nut screw portion 300, the bolt body 410 may move in the first direction or the second direction by the circulating movement of the ball member B.

The bolt head 420 may be arranged between the bolt body 410 and the piston portion 200. The bolt head 420 may be formed to have an approximately circular cross section. The bolt head 420 may be arranged to be inserted into the piston head 220. The bolt head 420 may be arranged to face the inner surface of the piston head 220 with a predetermined distance therebetween. When braking force is not generated or is released in the brake apparatus for a vehicle, the bolt head 420 may be spaced apart from the piston head 220.

The bolt head 420 may press the piston head 220. The bolt head 420 may press the piston head 220 in the first direction or release the pressure, depending on the moving direction of the bolt body 410.

The bolt head 420 may have a larger outer diameter than the bolt body 410. Accordingly, when the bolt screw portion 400 presses the piston portion 200 to move toward the brake pad 30, the contact diameter of the bolt screw portion 400 that is in contact with the piston portion 200 may be increased.

When the outer diameter of the bolt head 420 that is in contact with the piston head 220 is larger than the outer diameter of the bolt body 410, rather than being equal to or smaller than the outer diameter of the bolt body 410, the contact diameter of the bolt head 420 that is in contact with the piston head 220 is further increased, thereby improving the load transfer efficiency to the piston portion 200 through the bolt head 420. In addition, as the contact diameter of the bolt head 420 that is in contact with the piston head 220 is increased, the load may be stably transmitted to the piston portion 200, and centering of the bolt screw portion 400 may be stably maintained.

The bolt head 420 may include a head connection portion 421 and a head expansion portion 422.

The head connection portion 421 is a portion of the bolt head 420 facing the bolt body 410 and is coupled to the bolt body 410. The head expansion portion 422 may extend from the head connection portion 421 toward the piston head 210 and may have a larger outer diameter than the head connection portion 421. Accordingly, the contact diameter of the bolt screw portion 400 that is in contact with the piston portion 200 may be increased.

When the outer diameter of the head expansion portion 422 that is in contact with the piston head 220 is larger than the outer diameter of the head connection portion 421, rather than being equal to the outer diameter of the head connection portion 421, the contact diameter of the head expansion portion 422 that is in contact with the piston head 220 is further increased, thereby improving the load transfer efficiency to the piston portion 200 through the bolt head 420. In addition, as the contact diameter of the head expansion portion 422 that is in contact with the piston head 220 is increased, the load may be stably transmitted to the piston portion 200.

The head expansion portion 422 may include a curved surface portion 422a on the outer periphery facing the piston head 220. The curved surface portion 422a may have a convex curved surface toward the piston head 220 and may be formed along the whole outer periphery of the head expansion portion 422. The head expansion portion 422 may be in contact with the piston head 220 on the curved surface portion 422a.

The head expansion portion 422 may be in rolling contact with the piston head 220 on the curved surface portion 422a. That is, the head expansion portion 422 may be capable of rolling motion relative to the piston head 220 on the curved surface portion 422a.

The piston head 220 may include a planar portion 220a at an area in contact with the curved surface portion 422a. Accordingly, when the head expansion portion 422 is in contact with the piston head 220 due to movement of the bolt screw portion 400 in the first direction, the head expansion portion 422 having the convex curved surface portion 422a and the piston head 220 having the planar portion 220a may remain in contact even if the head expansion portion 422 performs rolling motion relative to the piston head 220.

When braking force is generated by friction between the brake disc 20 and the brake pad 30 due to the movement of the caliper body 100 may undergo partial deformation in response to the reaction force of the braking force. As a result, the cylinder 130 and the piston portion 200 may be slightly tilted relative to the central axis compared to a non-braking state. That is, in the braking state, the cylinder 130 and/or the piston portion 200 may be tilted at a slight angle relative to the central axis.

When the cylinder 130 and/or the piston portion 200 is tilted relative to the respective central axis, the head expansion portion 422 may be in rolling contact with the piston head 220 on the curved surface portion 422a. That is, when the cylinder 130 and/or the piston portion 200 is tilted relative to the central axis, the head expansion portion 422 may be capable of rolling motion relative to the piston head 220 on the curved surface portion 422a.

When the cylinder 130 and/or the piston portion 200 is tilted relative to the central axis, the head expansion portion 422 performs rolling motion relative to the piston head 220. This causes the bolt body 410, coupled to the bolt head 420, to tilt by the same angle as the bolt head 420 performs rolling motion.

When the cylinder 130 and/or the piston portion 200 is tilted relative to the central axis as described, the bolt head 420 and the bolt body 410 are also tilted, which prevents load concentration on any particular ball member B among the plurality of ball members B arranged in the longitudinal direction of the bolt body 410. This may ensure robustness of the bolt screw portion 400 against tilting of the cylinder 130 and/or the piston portion 200 and improve durability of the brake apparatus for a vehicle.

The bearing portion 500 may be arranged between the cylinder 130 and the nut screw portion 300 and support the nut screw portion 300 so that the nut screw portion 300 may rotate inside the cylinder 130.

When the cylinder 130 and/or the piston portion 200 is tilted relative to the respective central axis, the nut screw portion 300 may be in rolling contact with the bearing portion 500. That is, when the cylinder 130 and/or the piston portion 200 is tilted relative to the central axis, the nut screw portion 300 may be capable of rolling motion against the bearing portion 500.

When the cylinder 130 and/or the piston portion 200 is tilted relative to the central axis as described, the nut screw portion 300 is also tilted, which prevents load concentration of the nut screw portion 300 on any particular ball member B among the plurality of ball members B arranged in the longitudinal direction of the bolt body 410. This may ensure robustness of the bolt screw portion 400 against tilting of the cylinder 130 and/or the and improve durability of the brake apparatus for a vehicle.

The bearing portion 500 may include an outer ring portion 510 and a bearing ball 520.

The outer ring portion 510 is in contact with the inner surface of the cylinder 130. The outer ring portion 510 may be press-fitted into the cylinder 130 to be securely fixed in position. The bearing ball 520 may be arranged between the outer ring portion 510 and the nut screw body 310. In the present embodiment, the nut screw body 310 is illustrated as serving a role of an inner ring portion. However, the inner ring portion may be formed integrally with the nut screw body 310 as in the present embodiment, or may be formed separately from the nut screw body 310.

The nut screw body 310 may include a rolling contact portion 315, an upper step portion 316, and a lower bottom portion 317.

Since the nut screw body 310 serves the role of the inner ring portion, which is the rotating portion of the bearing portion 500, the nut screw body 310 may rotate relative to the outer ring portion 510. In addition, the nut screw body 310 is provided with the rolling contact portion 315 at an area facing the bearing ball 520, which enables rolling motion relative to the bearing ball 520. Since the nut screw body 310 may be capable of rolling motion relative to the bearing balls 520, an angle between the nut screw body 310 and the outer ring portion 510 may change.

The nut screw body 310 may have the upper step portion 316 formed on the piston head 220 side relative to the rolling contact portion 315, and the lower bottom portion 317 formed on the nut screw tail 320 side. The upper step portion 316 is a portion protruding outward compared to the lower bottom portion 317, and the rolling contact portion 315 may be formed between the upper step portion 316 and the lower bottom portion 317.

The rolling contact portion 315 may have a concave curved surface facing inward and may be formed along the whole outer periphery of the nut screw body 310. The bearing ball 520 may be in direct contact with the rolling contact portion 315 or in indirect contact with the rolling contact portion 315 through another member.

Since the rolling contact portion 315 includes a curved surface portion, the nut screw body 310 may be capable of rolling motion on the rolling contact portion 315 relative to the bearing ball 520 or the outer ring portion 510.

During braking of the brake apparatus for a vehicle, the piston portion 200 may be tilted relative to the central axis, or the cylinder 130 may be tilted relative to the central axis due to braking torque or the separation of the caliper body 100. According to the present embodiment, the bolt head 420 may be capable of rolling motion relative to the piston portion 200, which may prevent load concentration on any particular ball member B among the plurality of ball members B arranged on the outer surface of the bolt screw portion 400. According to the present embodiment, the nut screw portion 300 may be capable of rolling motion relative to the bearing portion 500, which may prevent load concentration on any particular ball member B among the plurality of ball members B arranged on the inner surface of the nut screw portion 300.

The brake apparatus for a vehicle according to the present embodiment may be capable of rolling motion at a front portion of the bolt screw portion 400, at an outer portion of the nut screw 300, or at both the front portion of the bolt screw portion 400 and the outer portion of the nut screw 300. Therefore, even when the piston portion 200 is tilted relative to the central axis or the cylinder 130 is tilted relative to the central axis, load concentration on any particular ball member B may be prevented. This may ensure robustness against tilting of the brake apparatus for a vehicle according to the present embodiment and improve durability of the apparatus.

The brake apparatus for a vehicle according to an embodiment of the present disclosure may further include an actuator portion 600.

The actuator portion 600 may receive power from a motor portion 660 and provide rotational force to the nut screw portion 300.

The actuator portion 600 may include a power transmission portion. The power transmission portion may be engaged with the nut screw portion 300 and transmit rotational force to the nut screw portion 300. By the rotational force provided from the actuator portion 600, the nut screw portion 300 rotates, causing the bolt screw portion 400 to translate.

The present embodiment is a nut screw-driven type brake apparatus for a vehicle in which the nut screw portion 300 is first rotated by receiving rotational force from the actuator portion 600, and the bolt screw portion 400, mechanically coupled with the nut screw portion 300 via the ball member B, is subsequently rotated. Therefore, according to the present embodiment, the axial length may be reduced compared to a bolt screw-driven type brake apparatus for a vehicle.

The power transmission portion may include a plurality of gears sequentially engaged and coupled between the motor portion 660 and the nut screw portion 300. The power transmission portion is not limited to the above configuration and may be modified to different types of power transmission means capable of receiving rotational force from the motor portion 660 and rotating the nut screw portion 300.

The power transmission portion may include a power transmission groove portion 620 arranged inside an actuator housing 610.

The power transmission groove portion 620 may be arranged to surround a rotation prevention protrusion 630, and the nut screw tail 320 of the nut screw portion 300 may be inserted therein.

The power transmission groove portion 620 may have a shape corresponding to the nut screw tail 320 so as to engage with the nut screw tail 320. The power transmission groove portion 620 may be formed as a non-circular groove portion. Non-circular refers to a shape that is not perfectly circular and includes shapes such as oval, polygonal, and others. In the present embodiment, the power transmission groove portion 620 is formed as a polygonal groove portion, specifically an approximately hexagonal groove portion.

The nut screw tail 320 and the power transmission groove portion 620 each have non-circular shapes that are the same or correspond to each other. Therefore, when the nut screw tail 320 is inserted into the power transmission groove portion 620, the nut screw tail 320 and the power transmission groove portion 620 engage with each other. Therefore, when the power transmission groove portion 620 rotates during operation of the actuator portion 600, the nut screw tail 320 engaged with the power transmission groove portion 620 also rotates in the same direction. Accordingly, the rotational force of the actuator portion 600 may be stably transmitted to the nut screw portion 300 without loss.

The actuator portion 600 may include a rotation prevention portion. The rotation prevention portion may engage with the bolt screw portion 400 to restrict the rotation of the bolt screw portion 400. The rotational force provided by the actuator portion 600 causes the nut screw portion 300 to rotate, thereby translating the bolt screw portion 400.

Since the nut screw portion 300 and the bolt screw portion 400 are mechanically coupled via the ball member B, the rotation of the bolt screw portion 400 is prevented by the rotation prevention portion so that the rotation of the nut screw portion 300 is converted into the translational movement of the bolt screw portion 400.

The rotation prevention portion may include a rotation prevention protrusion 630. The rotation prevention protrusion 630 may be arranged inside the actuator housing 610 and protrude outward from the actuator housing 610. The rotation prevention protrusion 630 may be arranged inside the power transmission groove portion 620.

When the nut screw tail 320 is inserted into and engaged with the power transmission groove portion 620, the rotation prevention protrusion 630 may be inserted into and engaged with a rotation prevention groove portion 411 of the bolt body 410. According to the present embodiment as described, since power transmission to the nut screw portion 300 and rotation prevention of the bolt screw portion 400 may be achieved through a single assembly, assemblability may be greatly improved.

The rotation prevention protrusion 630 may have a non-circular columnar shape. Non-circular refers to a shape that is not perfectly circular and includes shapes such as oval, polygonal, and others. In the present embodiment, the rotation prevention protrusion 630 has a polygonal columnar shape, specifically a substantially hexagonal columnar shape.

The rotation prevention groove portion 411 may be formed on the bolt body 410 with a shape corresponding to the rotation prevention protrusion 630 so as to engage with the rotation prevention protrusion 630. The rotation prevention groove portion 411 may be formed as a non-circular groove portion. Non-circular refers to a shape that is not perfectly circular and includes shapes such as oval, polygonal, and others. In the present embodiment, the rotation prevention groove portion 411 is formed as a polygonal groove portion, specifically as an approximately hexagonal groove portion.

The rotation prevention protrusion 630 and the rotation prevention groove portion 411 each have non-circular shapes that are the same or correspond to each other. Therefore, when the rotation prevention protrusion 630 is inserted into the rotation prevention groove portion 411, the rotation prevention protrusion 630 and the rotation prevention groove portion 411 engage with each other. Therefore, when the power transmission groove portion 620 rotates during operation of the actuator portion 600, the nut screw tail 320 engaged with the power transmission groove portion 620 rotates in the same direction, but the rotation of the bolt body 410 is prevented. Accordingly, the rotational force of the actuator portion 600 may be stably converted into the translational movement of the bolt screw portion 400 without loss.

Since the rotation prevention protrusion 630 and the rotation prevention groove portion 411 are in surface contact, frictional losses may be reduced when an axial forward load is generated, and centering of the bolt body 410 may be maintained. In addition, since the rotation prevention groove portion 411 may be integrally formed with the bolt body 410, there is no need to separately manufacture a rotation prevention structure, thereby improving space utilization.

The rotation prevention groove portion 411 may include an extended inclined surface 411a that expands outward to guide the precise insertion of the rotation prevention protrusion 630. The rotation prevention protrusion 630 may include a tapered inclined surface portion 630a on the outer side of the tip portion thereof to facilitate insertion into the rotation prevention groove portion 411.

The insertion length of the rotation prevention protrusion 630 into the bolt body 410 may be longer than the maximum stroke of the piston portion 200. The maximum stroke of the piston portion 200 refers to the distance by which the piston portion 200 moves from the original position to a fully forward position. The stroke of the piston portion 200 may increase by an amount corresponding to the wear of the brake pad 30. Accordingly, since the insertion length of the rotation prevention protrusion 630 into the bolt body 410 is longer than the maximum stroke of the piston portion 200, the rotation prevention protrusion 630 remains constantly engaged with the rotation prevention groove portion 411 of the bolt body 410, thereby continuously preventing the rotation of the bolt screw portion 400.

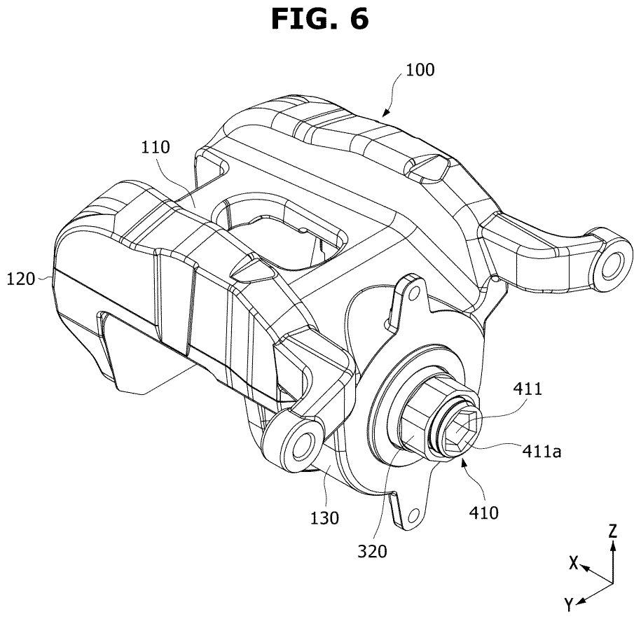

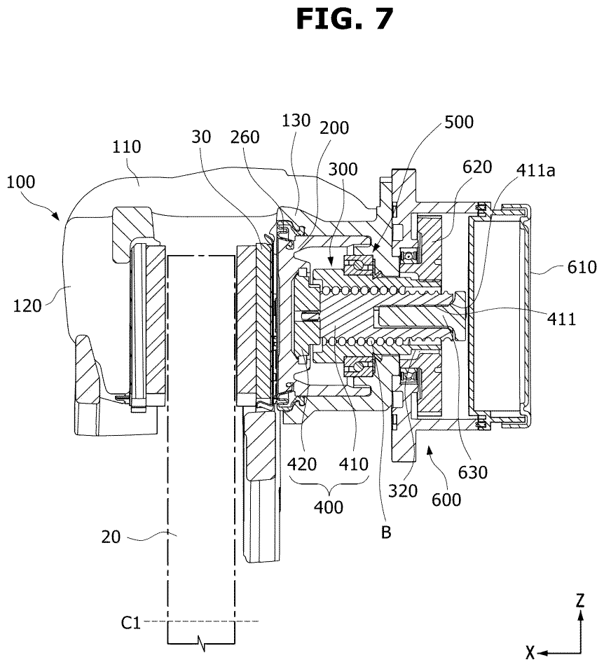

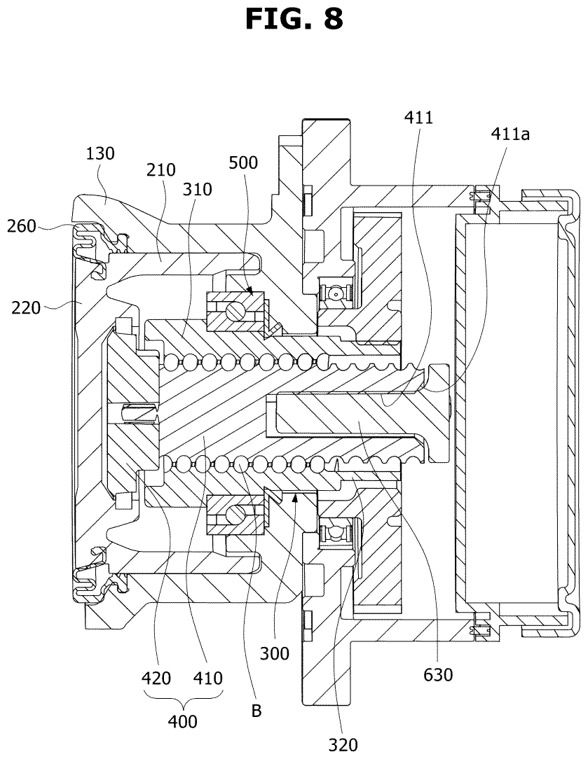

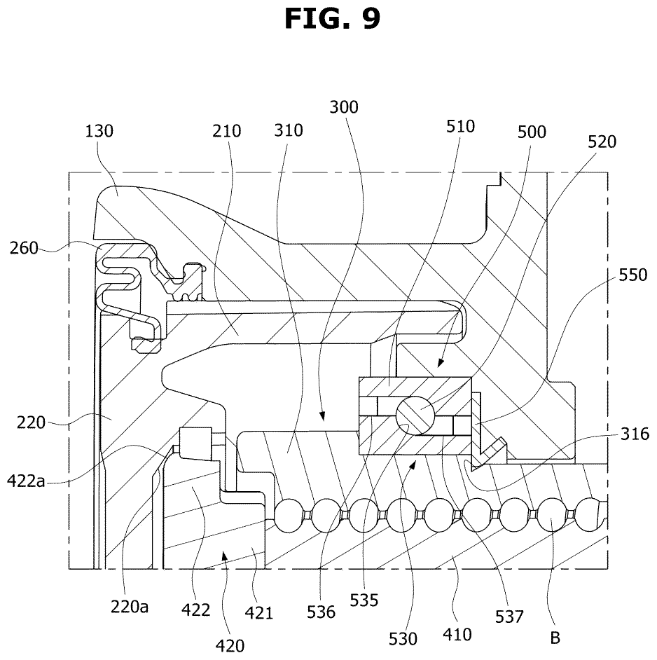

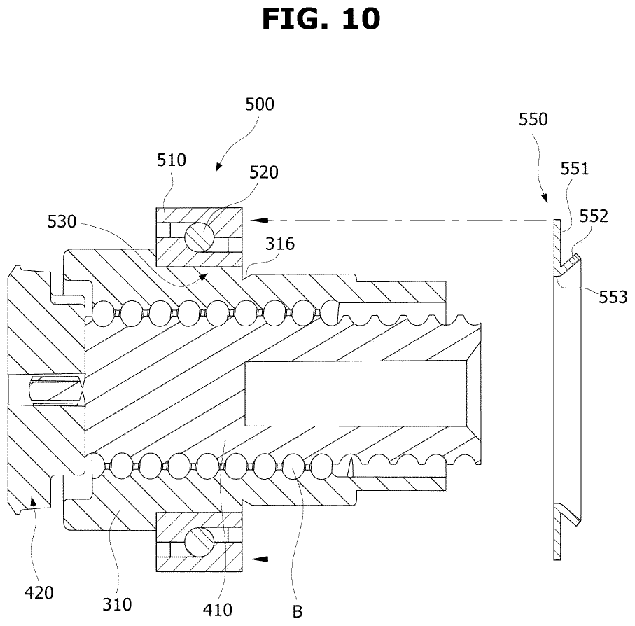

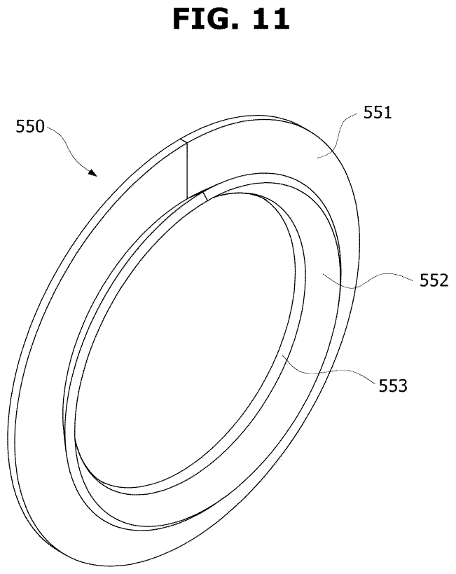

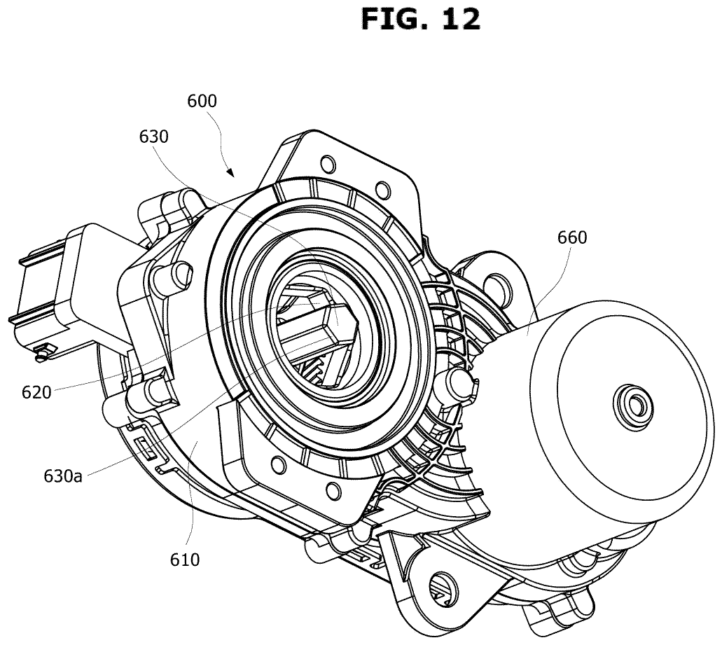

FIG. 6 is a perspective view showing a brake apparatus for a vehicle according to another embodiment of the present disclosure. FIG. 7 is a cross-sectional view schematically showing a brake apparatus for a vehicle according to the embodiment of the present disclosure. FIG. 8 is a partially enlarged view of FIG. 7. FIG. 9 is a partially enlarged view of FIG. 8. FIG. 10 is a view showing a state in which a position fixing portion is mounted to a nut screw portion in a brake apparatus for a vehicle according to the embodiment of the present disclosure. FIG. 11 is a perspective view of a position fixing portion according to the embodiment of the present disclosure. FIG. 12 is a perspective view showing an actuator portion of a brake apparatus for a vehicle according to the embodiment of the present disclosure.

Referring to FIGS. 6 to 12, a brake apparatus for a vehicle according to another embodiment of the present disclosure may include a caliper body 100, a piston portion 200, a nut screw portion 300, a bolt screw portion 400, and a bearing portion 500.

The caliper body 100 may form the outer shape of the brake apparatus for a vehicle and surround or support the piston portion 200, the nut screw portion 300, and the bolt screw portion 400.

The caliper body 100 may include a bridge 110, a finger 120, and a cylinder 130.

The bridge 110 may form the outer appearance of a central portion of the caliper body 100 and support the finger 120 and the cylinder 130. The bridge 110 may be connected to a carrier (not shown), which is fixed to a knuckle (not shown) or the like via a guide rod (not shown).

The lower surface of the bridge 110 may be arranged to face a circumferential surface of a brake disc 20 with a predetermined distance therebetween. Both sides of the bridge 110 may extend in a first direction (+X direction in FIG. 2) and in a second direction opposite to the first direction (−X direction in FIG. 2), relative to the brake disc 20.

A pair of brake pads 30 may be arranged below the bridge 110. The pair of brake pads 30 may be arranged to face each other with the brake disc 20 interposed therebetween.

One surface of the brake pad 30 facing the brake disc 20 may have a friction pad attached, which includes a material with a high coefficient of friction such as rubber.

The finger 120 may extend downward from one side of the bridge 110. The finger 120 may be arranged to face one of the pair of brake pads 30.

The cylinder 130 may extend downward from the opposite side of the bridge 110. The cylinder 130 may have a hollow columnar shape. One side of the cylinder 130 (left side in FIG. 2) may be arranged to face the other of the pair of brake pads 30.

One side of the cylinder 130 may be open, and the open side of the cylinder 130 may be spaced a predetermined distance apart from the brake pad 30 that is spaced in the second direction from the brake disc 20.

The central axis of the cylinder 130 may be arranged parallel to a central axis C1 of the brake disc 20. The central axis of the cylinder 130 may be spaced apart from the central axis C1 of the brake disc 20 along a third direction (+Z direction in FIG. 2).

The third direction may be perpendicular to the first and second directions and may be exemplified as the direction from the central axis C1 of the brake disc 20 toward the central axis of the cylinder 130.

When the lower surface of the bridge 110 is arranged parallel to the ground, the third direction may be the direction perpendicular to the ground, that is, the upward direction along the Z-axis based on FIG. 2.

The piston portion 200 may be movably arranged in the first direction (+X direction in FIG. 2) or the second direction (−X direction in FIG. 2) within the cylinder 130. The piston portion 200 may be arranged inside the cylinder 130.

The piston portion 200 may have a hollow columnar shape. The side of the piston portion 200 facing the brake pad 30 may be closed. The piston portion 200 may be arranged along the longitudinal direction of the cylinder 130.

The outer surface of the piston portion 200 may be slidably supported by the inner surface of the cylinder 130. Alternatively, the outer surface of the piston portion 200 may be spaced a predetermined distance apart from the inner surface of the cylinder 130.

The piston portion 200 may protrude outward from the cylinder 130 by moving in the first direction and press the brake pad 30, arranged to face the cylinder 130, toward the brake disc 20. This allows the brake apparatus for a vehicle to generate braking force.

In response to movement of the piston portion 200 in the second direction, the piston portion 200 may be separated from the brake pad 30. Accordingly, the pressing force applied by the piston portion 200 to the brake pad 30 is released, and the braking force of the brake apparatus for a vehicle disappears.

The piston portion 200 may include a piston body 210 and a piston head 220.

The piston body 210 may have a hollow columnar shape, and the piston head 220 may be connected to the piston body 210 to close one side of the piston body 210 (left side in FIG. 2). The piston head 220 is arranged on the side that faces the brake pad 30 between the two open sides of the piston body 210, and closes the open area of the piston body 210.

A bolt screw portion 400 may be arranged inside the piston portion 200. A bolt body 410 and a bolt head 420 of the bolt screw portion 400 are surrounded by the piston body 210. The bolt head 420 may be arranged to be inserted into the piston head 220.

A piston boot 260 may be installed inside the cylinder 130 to prevent the entry of external foreign substances and to seal the interior of the cylinder 130. The piston boot 260 may be installed between the cylinder 130 and the piston portion 200. The piston boot 260 may be coupled to the piston body 210 or the piston head 220 and press-fitted inside the cylinder 130.

The piston boot 260 may be formed to surround the piston portion 200. The piston boot 260 may include an elastically deformable material. For example, the piston boot 260 may be made of a rubber material. The piston boot 260 may be formed to have a corrugated shape.

The nut screw portion 300 may be rotatably arranged in the cylinder 130 and coupled to the bolt screw portion 400. A bearing portion 500 that rotatably supports the nut screw portion 300 may be installed inside the cylinder 130. The bearing portion 500 may be a ball bearing arranged between the cylinder 130 and the nut screw portion 300.

The nut screw portion 300 may have a hollow columnar shape with both end portions open. The nut screw portion 300 may be arranged inside the cylinder 130, and the central axis thereof may be aligned coaxially with the central axis of the cylinder.

One side of the nut screw portion 300 (left side in FIG. 2) may be arranged to face the inner surface of the piston portion 200 (right side in FIG. 2) with a predetermined distance therebetween. The other side of the nut screw portion 300 (right side in FIG. 2) may pass through the cylinder 130 and protrude outward from the cylinder 130.

The inner surface of the nut screw portion 300 may be arranged to face the outer surface of the bolt screw portion 400. The inner peripheral surface of the nut screw portion 300 may be formed with a ball rail on which one side circumference of a spherical ball member B is seated. This ball rail may extend helically along the longitudinal direction of the nut screw portion 300 to provide a circulation path for the ball member B.

The nut screw portion 300 may receive rotational force generated from the actuator portion 600 through a power transmission portion during operation of the actuator portion 600, and may rotate clockwise or counterclockwise about the central axis.

The nut screw portion 300 may include a nut screw body 310 and a nut screw tail 320.

Most of the nut screw body 310 may be arranged inside the cylinder 130, and the nut screw tail 320 may be entirely or mostly exposed outside the cylinder 130. The nut screw body 310 may be surrounded by the piston body 210.

The nut screw tail 320 may have a non-circular columnar shape. Non-circular refers to a shape that is not perfectly circular and includes shapes such as oval, polygonal, and others. In the present embodiment, the nut screw tail 320 has a polygonal columnar shape, specifically a substantially hexagonal columnar shape.

The bolt screw portion 400 may move in the first direction and the second direction inside the cylinder 130 in response to rotation of the nut screw portion 300. The bolt screw portion 400 may be arranged inside the nut screw portion 300. The bolt screw portion 400 may be arranged to pass through both end portions of the nut screw portion 300.

The bolt screw portion 400 may move in the first direction, which is a direction toward the brake pad 30, so that the piston portion 200 presses the brake pad 30. In addition, the bolt screw portion 400 may move in the second direction, opposite to the first direction, to release pressure on the piston portion 200.

The bolt screw portion 400 may include a bolt body 410 and a bolt head 420.

The bolt body 410 may be coupled to the nut screw portion 300 and receive rotational force from the nut screw portion 300. The bolt head 420 may be provided separately from the bolt body 410. The bolt body 410 may be press-fitted and integrated with the bolt head 420. For example, the bolt body 410 may be press-fitted with serration to the bolt head 420.

Since the bolt head 420 is manufactured separately from the bolt body 410, the shape flexibility of the bolt head 420 may be improved. In particular, depending on the specifications of the brake apparatus for a vehicle, the shape of the bolt head 420 may be modified. By forming the bolt head 420 separately from the bolt body 410 that is relatively easy to standardize, customization is facilitated and design freedom increases. According to the present embodiment, based on changes in the size of the piston portion 200, the contact diameter of the bolt head 420 may be easily changed accordingly.

When the bolt body 410 moves translationally in the first direction inside the cylinder 130 in response to the rotation of the nut screw portion 300, the bolt head 420 arranged in front of the bolt body 410 (left side in FIG. 2) presses the piston portion 200.

The bolt body 410 may have a columnar shape with an approximately circular cross-section. The bolt body 410 may be arranged inside the cylinder 130, and the central axis thereof may be aligned coaxially with the central axis of the cylinder 130. The bolt body 410 may be coupled to the nut screw portion 300 via the ball member B.

The outer peripheral surface of the bolt body 410 may be formed with a ball rail (not shown) on which the ball member B is seated. The ball rail may extend helically along the longitudinal direction (left-right direction in FIG. 2) of the bolt body 410 to provide a circulation path for the ball member B. Accordingly, in response to rotation of the nut screw portion 300, the bolt body 410 may move in the first direction or the second direction by the circulating movement of the ball member B.

The bolt head 420 may be arranged between the bolt body 410 and the piston portion 200. The bolt head 420 may be formed to have an approximately circular cross section. The bolt head 420 may be arranged to be inserted into the piston head 220. The bolt head 420 may be arranged to face the inner surface of the piston head 220 with a predetermined distance therebetween. When braking force is not generated or is released in the brake apparatus for a vehicle, the bolt head 420 may be spaced apart from the piston head 220.

The bolt head 420 may press the piston head 220. The bolt head 420 may press the piston head 220 in the first direction or release the pressure, depending on the moving direction of the bolt body 410.

The bolt head 420 may have a larger outer diameter than the bolt body 410. Accordingly, when the bolt screw portion 400 presses the piston portion 200 to move toward the brake pad 30, the contact diameter of the bolt screw portion 400 that is in contact with the piston portion 200 may be increased.

When the outer diameter of the bolt head 420 that is in contact with the piston head 220 is larger than the outer diameter of the bolt body 410, rather than being equal to or smaller than the outer diameter of the bolt body 410, the contact diameter of the bolt head 420 that is in contact with the piston head 220 is further increased, thereby improving the load transfer efficiency to the piston portion 200 through the bolt head 420. In addition, as the contact diameter of the bolt head 420 that is in contact with the piston head 220 is increased, the load may be stably transmitted to the piston portion 200, and centering of the bolt screw portion 400 may be stably maintained.

The bolt head 420 may include a head connection portion 421 and a head expansion portion 422.

The head connection portion 421 is a portion of the bolt head 420 facing the bolt body 410 and is coupled to the bolt body 410. The head expansion portion 422 may extend from the head connection portion 421 toward the piston head 210 and may have a larger outer diameter than the head connection portion 421. Accordingly, the contact diameter of the bolt screw portion 400 that is in contact with the piston portion 200 may be increased.

When the outer diameter of the head expansion portion 422 that is in contact with the piston head 220 is larger than the outer diameter of the head connection portion 421, rather than being equal to the outer diameter of the head connection portion 421, the contact diameter of the head expansion portion 422 that is in contact with the piston head 220 is further increased, thereby improving the load transfer efficiency to the piston portion 200 through the bolt head 420. In addition, as the contact diameter of the head expansion portion 422 that is in contact with the piston head 220 is increased, the load may be stably transmitted to the piston portion 200.

The head expansion portion 422 may include a curved surface portion 422a on the outer periphery facing the piston head 220. The curved surface portion 422a may have a convex curved surface toward the piston head 220 and may be formed along the whole outer periphery of the head expansion portion 422. The head expansion portion 422 may be in contact with the piston head 220 on the curved surface portion 422a.

The head expansion portion 422 may be in rolling contact with the piston head 220 on the curved surface portion 422a. That is, the head expansion portion 422 may be capable of rolling motion relative to the piston head 220 on the curved surface portion 422a.

The piston head 220 may include a planar portion 220a at an area in contact with the curved surface portion 422a. Accordingly, when the head expansion portion 422 is in contact with the piston head 220 due to movement of the bolt screw portion 400 in the first direction, the head expansion portion 422 having the convex curved surface portion 422a and the piston head 220 having the planar portion 220a may remain in contact even if the head expansion portion 422 performs rolling motion relative to the piston head 220.

When braking force is generated by friction between the brake disc 20 and the brake pad 30 due to the movement of the, the caliper body 100 may undergo partial deformation in response to the reaction force of the braking force. As a result, the cylinder 130 and the piston portion 200 may be slightly tilted relative to the central axis compared to a non-braking state. That is, in the braking state, the cylinder 130 and/or the piston portion 200 may be tilted at a slight angle relative to the central axis.

When the cylinder 130 and/or the piston portion 200 is tilted relative to the respective central axis, the head expansion portion 422 may be in rolling contact with the piston head 220 on the curved surface portion 422a. That is, when the cylinder 130 and/or the piston portion 200 is tilted relative to the central axis, the head expansion portion 422 may be capable of rolling motion relative to the piston head 220 on the curved surface portion 422a.

When the cylinder 130 and/or the piston portion 200 is tilted relative to the central axis, the head expansion portion 422 performs rolling motion relative to the piston head 220. This causes the bolt body 410, coupled to the bolt head 420, to tilt by the same angle as the bolt head 420 performs rolling motion.

When the cylinder 130 and/or the piston portion 200 is tilted relative to the central axis as described, the bolt head 420 and the bolt body 410 are also tilted, which prevents load concentration on any particular ball member B among the plurality of ball members B arranged in the longitudinal direction of the bolt body 410. This may ensure robustness of the bolt screw portion 400 against tilting of the cylinder 130 and/or the and improve durability of the brake apparatus for a vehicle.

The bearing portion 500 may be arranged between the cylinder 130 and the nut screw portion 300 and support the nut screw portion 300 so that the nut screw portion 300 may rotate inside the cylinder 130.

The bearing portion 500 may include an outer ring portion 510, a bearing ball 520, and an inner ring portion 530.

The outer ring portion 510 is in contact with the inner surface of the cylinder 130. The outer ring portion 510 may be press-fitted into the cylinder 130 to be securely fixed in position. The inner ring portion 530 may be rotatably arranged inside the outer ring portion 510 and be coupled to the nut screw portion 300. The inner ring portion 530 may be press-fitted and integrated with the nut screw body 310. The bearing ball 520 may be arranged between the outer ring portion 510 and the inner ring portion 530, and reduce friction during rotation of the inner ring portion 530.

The brake apparatus for a vehicle according to another embodiment of the present disclosure may include a position fixing ring portion 550. The position fixing ring portion 550 may contact and support the bearing portion 500 from a rear side of the piston head 220, so that the bearing portion 500 may be fixed in position on the nut screw portion 300.

The position fixing ring portion 550 may include a contact plate portion 551. The contact plate portion 551 may have a ring shape and contact and support the bearing portion 500 from the rear. The contact plate portion 551 may be formed to extend from a portion facing the inner ring portion 530 to a portion facing the outer ring portion 510. Accordingly, the contact plate portion 551 may be in contact not only with the inner ring portion 530 but also with at least part of the outer ring portion 510, thereby stably supporting the bearing portion 500.

The position fixing ring portion 550 may have a cross section that is approximately V-shaped. The position fixing ring portion 550 may include the contact plate portion 551 that is in contact with the bearing portion 500 and an inclined plate portion 552 connected to the contact plate portion 551. The connection area between the contact plate portion 551 and the inclined plate portion 552 may be an edge portion 553 forming a V-shaped corner. The edge portion 553 may be formed sharply or may be formed more gently.

The nut screw body 310 of the nut screw portion 300 may be provided with an insertion groove portion 316 into which the position fixing ring portion 550, specifically the edge portion 553, is inserted. The position fixing ring portion 550 is mounted by insertion into the insertion groove portion 316 during the process of being mounted on the nut screw portion 300, so that the position fixing ring portion 550 may be firmly fixed on the nut screw body 310. This allows the position fixing ring portion 550 to firmly fix the bearing portion 500 in position on the nut screw body 310.

The position fixing ring portion 550 may include an elastically deformable material. The position fixing ring portion 550 may elastically deform and expand during movement along the periphery of the nut screw body 310, and elastically restore when mounted into the insertion groove portion 316. Accordingly, the position fixing ring portion 550 may be more easily mounted into the insertion groove portion 316.

When the cylinder 130 and/or the is tilted relative to the respective central axis, the inner ring portion 530 or the outer ring portion 510 may be in rolling contact with the bearing ball 520. That is, when the cylinder 130 and/or the piston portion 200 is tilted relative to the central axis, the inner ring portion 530 or the outer ring portion 510 may be capable of rolling motion relative to the bearing ball 520.

When the cylinder 130 and/or the piston portion 200 is tilted relative to the central axis as described, the nut screw portion 300 is also tilted as the inner ring portion performs rolling motion, which prevents load concentration of the nut screw portion 300 on any particular ball member B among the plurality of ball members B arranged in the longitudinal direction of the bolt body 410. This may ensure robustness of the bolt screw portion 400 against tilting of the cylinder 130 and/or the, thereby improving durability of the brake apparatus for a vehicle.

The inner ring portion 530 may include a rolling contact portion 535, an upper step portion 536, and a lower bottom portion 537.

Since the inner ring portion 530 is provided with the rolling contact portion 535 at an area facing or contacting the bearing ball 520, the inner ring portion 530 may be capable of rolling motion relative to the bearing ball 520. Since the outer ring portion 510 is provided with the rolling contact portion (not shown) at an area facing or contacting the bearing ball 520, the outer ring portion 510 may be capable of rolling motion relative to the bearing ball 520.

The inner ring portion 530 may have the upper step portion 536 formed on the piston head 220 side relative to the rolling contact portion 535, and the lower bottom portion 537 formed on the nut screw tail 320 side. The upper step portion 536 is a portion protruding outward compared to the lower bottom portion 537, and the rolling contact portion 535 may be formed between the upper step portion 536 and the lower bottom portion 537.

The rolling contact portion 535 may be formed as a concave curved surface facing inward and may be formed along the whole outer periphery of the inner ring portion 530. The bearing ball 520 may be in direct contact with the rolling contact portion 535 or in indirect contact through another member.

Since the rolling contact portion 535 includes a curved surface portion, the nut screw body 310 may be capable of rolling motion relative to the cylinder 130.

During braking of the brake apparatus for a vehicle, the piston portion 200 may be tilted relative to the central axis, or the cylinder 130 may be tilted relative to the central axis due to braking torque or the separation of the caliper body 100. According to the present embodiment, the bolt head 420 may be capable of rolling motion relative to the piston portion 200, which may prevent load concentration on any particular ball member B among the plurality of ball members B arranged on the outer surface of the bolt screw portion 400. In addition, according to the present embodiment, since the inner ring portion 530 performs rolling motion relative to the bearing ball 520, the nut screw portion 300 is capable of rolling motion relative to the cylinder 130. Therefore, this may prevent load concentration on any particular ball member B among the plurality of ball members B arranged on the inner surface of the nut screw portion 300.

The brake apparatus for a vehicle according to the present embodiment may be capable of rolling motion at a front portion of the bolt screw portion 400, at an outer portion of the nut screw 300, or at both the front portion of the bolt screw portion 400 and the outer portion of the nut screw 300. Therefore, even when the piston portion 200 is tilted relative to the central axis or the cylinder 130 is tilted relative to the central axis, load concentration on any particular ball member B may be prevented. This may ensure robustness against tilting of the brake apparatus for a vehicle according to the present embodiment and improve durability of the apparatus.

The brake apparatus for a vehicle according to another embodiment of the present disclosure may further include an actuator portion 600.

The actuator portion 600 may receive power from a motor portion 660 and provide rotational force to the nut screw portion 300.

The actuator portion 600 may include a power transmission portion. The power transmission portion may be engaged with the nut screw portion 300 and transmit rotational force to the nut screw portion 300. By the rotational force provided from the actuator portion 600, the nut screw portion 300 rotates, causing the bolt screw portion 400 to translate.

The present embodiment is a nut screw-driven type brake apparatus for a vehicle in which the nut screw portion 300 is first rotated by receiving rotational force from the actuator portion 600, and the bolt screw portion 400, mechanically coupled with the nut screw portion 300 via the ball member B, is subsequently rotated. Therefore, according to the present embodiment, the axial length may be reduced compared to a bolt screw-driven type brake apparatus for a vehicle.

The power transmission portion may include a plurality of gears sequentially engaged and coupled between the motor portion 660 and the nut screw portion 300. The power transmission portion is not limited to the above configuration and may be modified to different types of power transmission means capable of receiving rotational force from the motor portion 660 and rotating the nut screw portion 300.

The power transmission portion may include a power transmission groove portion 620 arranged inside an actuator housing 610.

The power transmission groove portion 620 may be arranged to surround a rotation prevention protrusion 630, and the nut screw tail 320 of the nut screw portion 300 may be inserted therein.

The power transmission groove portion 620 may have a shape corresponding to the nut screw tail 320 so as to engage with the nut screw tail 320. The power transmission groove portion 620 may be formed as a non-circular groove portion. Non-circular refers to a shape that is not perfectly circular and includes shapes such as oval, polygonal, and others. In the present embodiment, the power transmission groove portion 620 is formed as a polygonal groove portion, specifically an approximately hexagonal groove portion.

The nut screw tail 320 and the power transmission groove portion 620 each have non-circular shapes that are the same or correspond to each other. Therefore, when the nut screw tail 320 is inserted into the power transmission groove portion 620, the nut screw tail 320 and the power transmission groove portion 620 engage with each other. Therefore, when the power transmission groove portion 620 rotates during operation of the actuator portion 600, the nut screw tail 320 engaged with the power transmission groove portion 620 also rotates in the same direction. Accordingly, the rotational force of the actuator portion 600 may be stably transmitted to the nut screw portion 300 without loss.

The actuator portion 600 may include a rotation prevention portion. The rotation prevention portion may engage with the bolt screw portion 400 to restrict the rotation of the bolt screw portion 400. The rotational force provided by the actuator portion 600 causes the nut screw portion 300 to rotate, thereby translating the bolt screw portion 400.

Since the nut screw portion 300 and the bolt screw portion 400 are mechanically coupled via the ball member B, the rotation of the bolt screw portion 400 is prevented by the rotation prevention portion so that the rotation of the nut screw portion 300 is converted into the translational movement of the bolt screw portion 400.

The rotation prevention portion may include a rotation prevention protrusion 630. The rotation prevention protrusion 630 may be arranged inside the actuator housing 610 and protrude outward from the actuator housing 610. The rotation prevention protrusion 630 may be arranged inside the power transmission groove portion 620.

When the nut screw tail 320 is inserted into and engaged with the power transmission groove portion 620, the rotation prevention protrusion 630 may be inserted into and engaged with a rotation prevention groove portion 411 of the bolt body 410. According to the present embodiment as described, since power transmission to the nut screw portion 300 and rotation prevention of the bolt screw portion 400 may be achieved through a single assembly, assemblability may be greatly improved.

The rotation prevention protrusion 630 may have a non-circular columnar shape. Non-circular refers to a shape that is not perfectly circular and includes shapes such as oval, polygonal, and others. In the present embodiment, the rotation prevention protrusion 630 has a polygonal columnar shape, specifically a substantially hexagonal columnar shape.

The rotation prevention groove portion 411 may be formed on the bolt body 410 with a shape corresponding to the rotation prevention protrusion 630 so as to engage with the rotation prevention protrusion 630. The rotation prevention groove portion 411 may be formed as a non-circular groove portion. Non-circular refers to a shape that is not perfectly circular and includes shapes such as oval, polygonal, and others. In the present embodiment, the rotation prevention groove portion 411 is formed as a polygonal groove portion, specifically as an approximately hexagonal groove portion.

The rotation prevention protrusion 630 and the rotation prevention groove portion 411 each have non-circular shapes that are the same or correspond to each other. Therefore, when the rotation prevention protrusion 630 is inserted into the rotation prevention groove portion 411, the rotation prevention protrusion 630 and the rotation prevention groove portion 411 engage with each other. Therefore, when the power transmission groove portion 620 rotates during operation of the actuator portion 600, the nut screw tail 320 engaged with the power transmission groove portion 620 rotates in the same direction, but the rotation of the bolt body 410 is prevented. Accordingly, the rotational force of the actuator portion 600 may be stably converted into the translational movement of the bolt screw portion 400 without loss.

Since the rotation prevention protrusion 630 and the rotation prevention groove portion 411 are in surface contact, frictional losses may be reduced when an axial forward load is generated, and centering of the bolt body 410 may be maintained. In addition, since the rotation prevention groove portion 411 may be integrally formed with the bolt body 410, there is no need to separately manufacture a rotation prevention structure, thereby improving space utilization.

The rotation prevention groove portion 411 may include an extended inclined surface 411a that expands outward to guide the precise insertion of the rotation prevention protrusion 630. The rotation prevention protrusion 630 may include a tapered inclined surface portion 630a on the outer side of the tip portion thereof to facilitate insertion into the rotation prevention groove portion 411.

The insertion length of the rotation prevention protrusion 630 into the bolt body 410 may be longer than the maximum stroke of the piston portion 200. The maximum stroke of the piston portion 200 refers to the distance by which the piston portion 200 moves from the original position to a fully forward position. The stroke of the piston portion 200 may increase by an amount corresponding to the wear of the brake pad 30. Accordingly, since the insertion length of the rotation prevention protrusion 630 into the bolt body 410 is longer than the maximum stroke of the piston portion 200, the rotation prevention protrusion 630 remains constantly engaged with the rotation prevention groove portion 411 of the bolt body 410, thereby continuously preventing the rotation of the bolt screw portion 400.

Although embodiments of the present disclosure have been described with reference to the accompanying drawings, these embodiments are merely exemplary, and those skilled in the art will appreciate that various modifications and other equivalent embodiments can be made from these embodiments disclosed herein. Thus, the true technical scope of the disclosure should be defined by the following claims.

What is claimed is:

1. A brake apparatus for a vehicle, the brake apparatus comprising:
a caliper body including a cylinder;
a piston portion movably arranged in the cylinder and arranged to face a brake pad of the vehicle;
a nut screw portion arranged in the piston portion and configured to receive rotational force from an actuator portion and rotate accordingly; and
a bolt screw portion including a bolt body coupled to the nut screw portion and configured to receive rotational force from the nut screw portion, and a bolt head separately disposed from the bolt body, coupled to the bolt body, and arranged to face the piston portion, wherein the bolt head presses the piston portion as the bolt body moves inside the cylinder in response to rotation of the nut screw portion.

2. The brake apparatus of claim 1, wherein the bolt head has a larger outer diameter than the bolt body.

3. The brake apparatus of claim 2, wherein the bolt head includes:
a head connection portion coupled to the bolt body; and
a head expansion portion configured to extend from the head connection portion toward the piston portion and have a larger outer diameter than the head connection portion.

4. The brake apparatus of claim 3, wherein the head expansion portion includes a curved surface portion on an outer periphery facing the piston portion, and the head expansion portion is in contact with the piston portion on the curved surface portion.

5. The brake apparatus of claim 4, wherein in response to tilting of the piston portion relative to a central axis, the head expansion portion performs rolling motion relative to the piston portion on the curved surface portion.

6. The brake apparatus of claim 5, wherein the piston portion has a planar portion at an area in contact with the curved surface portion.

7. The brake apparatus of claim 1, wherein the bolt body is coupled to the nut screw portion via a ball member on an inner surface of the nut screw portion.

8. The brake apparatus of claim 1, further comprising:
a bearing portion arranged between the cylinder and the nut screw portion, and configured to support the nut screw portion to allow the nut screw portion to rotate in the cylinder.

9. The brake apparatus of claim 8, wherein in response to tilting of the piston portion relative to a central axis, the nut screw portion performs rolling motion relative to the bearing portion.

10. The brake apparatus of claim 9, wherein the bearing portion includes:
an outer ring portion in contact with an inner surface of the cylinder; and
a bearing ball arranged between the outer ring portion and the nut screw portion,
wherein the nut screw portion has a rolling contact portion at an area facing the bearing ball.

11. A brake apparatus for a vehicle, the brake apparatus comprising:
a caliper body including a cylinder;
a piston portion movably arranged in the cylinder and arranged to face a brake pad of the vehicle;
a nut screw portion arranged in the piston portion and configured to receive rotational force from an actuator portion and rotate accordingly;
a bolt screw portion configured to move inside the cylinder in response to rotation of the nut screw portion and press the piston portion;
a bearing portion arranged between the cylinder and the nut screw portion, and configured to support the nut screw portion to allow the nut screw portion to rotate in the cylinder; and
a position fixing ring portion configured to contact and support the bearing portion to fix the bearing portion in a position on the nut screw portion.

12. The brake apparatus of claim 11, wherein the bearing portion includes:
an outer ring portion in contact with an inner surface of the cylinder;
an inner ring portion rotatably arranged inside the outer ring portion and configured to be in contact with the nut screw portion; and
a bearing ball arranged between the outer ring portion and the inner ring portion.

13. The brake apparatus of claim 12, wherein the position fixing ring portion includes a contact plate portion that is in contact with at least part of the outer ring portion.

14. The brake apparatus of claim 13, wherein an insertion groove portion into which the position fixing ring portion is inserted is provided on an outer surface of the nut screw portion.

15. The brake apparatus of claim 14, wherein the position fixing ring portion has a V-shaped cross section, and an edge portion of the position fixing ring portion is inserted into the insertion groove portion.

16. The brake apparatus of claim 14, wherein the position fixing ring portion includes an elastically deformable material.

17. The brake apparatus of claim 12, wherein the inner ring portion has a rolling contact portion at an area facing the bearing ball.

18. The brake apparatus of claim 17, wherein the inner ring portion includes:
a lower bottom portion connected to one side of the rolling contact portion; and
an upper step portion connected to an opposite side of the rolling contact portion and configured to protrude outward compared to the lower bottom portion.

19. The brake apparatus of claim 18, wherein the rolling contact portion is formed as a concave curved surface facing inward and formed along a whole outer periphery of the inner ring portion.
